(19) United States
(12) Patent Application Publication
(10) Pub. No.: US 2026/0270989 A1
(43) Pub. Date: Sep. 10, 2026

(54) UTO SIGNALING FOR XR DESIGN

(71) Applicant: APPLE INC., Cupertino, CA (US)

(72) Inventors: Weidong Yang, San Diego, CA (US); Chunhai Yao, Beijing (CN); Hong He, San Jose, CA (US); Dawei Zhang, Saratoga, CA (US); Wei Zeng, San Diego, CA (US); Ankit Bhamri, Bad Nauheim (DE); Dan Wu, Beijing (CN)

(21) Appl. No.: 19/167,617

(22) PCT Filed: May 11, 2023
(86) PCT No.: PCT/CN2023/093592

§ 371 Date: Sep. 22, 2025

(51) Int. Cl. H04W 72/1268; H04W 72/21

(52) U.S. Cl. CPC H04W 72/1268; H04W 72/21

(57) ABSTRACT

Embodiments herein include a user equipment (UE) that receives, from a network node, a first configure grant (CG) configuration comprising multiple transmission occasions. The UE may generate an unused transmission occasion uplink control information (UTO-UCI) comprising a bitmap indicating one or more unused transmission occasions for a time period. The bitmap may have a bit size that is based on a duration of the time period and a timing reference or a starting transmission occasion corresponding to a beginning of the time period. The UE may send the UTO-UCI via a CG physical uplink channel (PUSCH) to the network node to indicate to the network node which of the transmission occasions are unused by the UE for the first CG configuration.

### TECHNICAL FIELD

This application relates generally to wireless communication systems, including uplink control information indicating unused transmission occasions for configure grant PUSCH transmission occasions.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a timeline of a physical downlink control channel and a PUSCH in accordance with some embodiments.

FIG. 2 illustrates three TDRA design choices in accordance with some embodiments.

FIG. 3 illustrates a transmission timeline for the unlicensed spectrum and a transmission timeline 304 for the licensed spectrum using a harmonized design in accordance with some embodiments.

FIG. 4 illustrates a series of PUSCH transmissions for a CG configuration in accordance with some embodiments.

FIG. 5 illustrates a first example bitmap for UTO-UCI in accordance with some embodiments.

FIG. 6 illustrates a second example bitmap for UTO-UCI in accordance with some embodiments

FIG. 7 illustrates a CG configuration timeline in accordance with some embodiments.

FIG. 8 illustrates two CG configurations in accordance with some embodiments.

FIG. 9 illustrates two CG configurations utilizing independent UTO indications in accordance with some embodiments.

FIG. 10 illustrates two CG configurations utilizing a single UTO indication for both CG configurations in accordance with some embodiments.

FIG. 11 illustrates a flowchart of a method for a UE according to embodiments herein.

FIG. 12 illustrates a flowchart of a method for a network node according to embodiments herein.

FIG. 13 illustrates an example architecture of a wireless communication system, according to embodiments disclosed herein.

FIG. 14 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Currently, wireless communication systems are incorporating extended reality (XR) use cases. However, there are several differences between XR traffic and conventional cellular traffic. Accordingly, enhancements for XR use cases are desirable. XR is a term that refers immersive technologies such as augmented reality (AR), virtual reality (VR), and mixed reality (MR). The XR use cases typically feature lots of audio and video content. Wireless communication systems may employ strategies to handle such traffic that differ from conventional cellular traffic.

One difference between XR traffic and conventional cellular traffic is that data may be transmitted by a UE to a network node using adjustable frame sizes that may vary in size depending on the amount of data to be transmitted. The data may be transmitted in a periodical schedule. Due to its periodical nature, a configure grant (CG) design was adopted for the uplink XR traffic.

However, even though the uplink data may be periodical, the changes in size of the data frames may make the current CG design inefficient for XR use cases. For example, currently the CG configuration does not support a change in size. Instead, the network will over provision the resources for the UE. For example, the UE may be configured with a periodical resource that is the size of the larges frame. However, for the frames that are smaller, the resources are wasted. Accordingly, it may be advantageous for the UE to inform the network node of how many resources are needed. The network node may then be able to utilize the additional resources.

Embodiments herein may use an unused transmission occasion(s) uplink control information (UTO-UCI) to provide a bitmap where a bit corresponds to a transmission occasion within a time duration/range. The bit indicates whether the transmission is unused. Embodiments herein provide details including the size and timing reference of the UTO-UCI. For a CG PUSCH configuration, the UTO-UCI may be included in every CG PUSCH that is transmitted.

Further, there may be occasions where multiple physical uplink channel (PUSCH) messages may be sent by a UE. The multiple PUSCH messages may be sent on different spectrums (e.g., unlicensed spectrum and licensed spectrum). Accordingly, to prevent collisions it may be advantageous to harmonize the design for PUSCH messages on the unlicensed spectrum and the licensed spectrum.

Additionally, there may be times when the UE is transmitting using multiple CG configurations. Enhancements may be made to accommodate use of multiple CG configurations. Embodiments herein provide details of how the unused transmission occasions can be associated to multiple CG configuration using one or multiple UTO-UCIs.

Some embodiments herein consider the harmonization of time domain resource assignment (TDRA) design between a new radio-unlicensed (NR-U) framework and multiple PUSCH transmission framework. In some embodiments, for unlicensed spectrum access, if the multiple PUSCH design is adopted, no gap is between different PUSCHs. For example, PUSCHs may have different durations, but there may be no gap between them. Further, some embodiments include design options and a number of variations for unused transmission occasion(s) (UTO) signaling generated for different CG configurations. The different design options and variations may lead to different treatment for signaling generation, CG generation, UCI multiplexing and network node blind detection behavior.

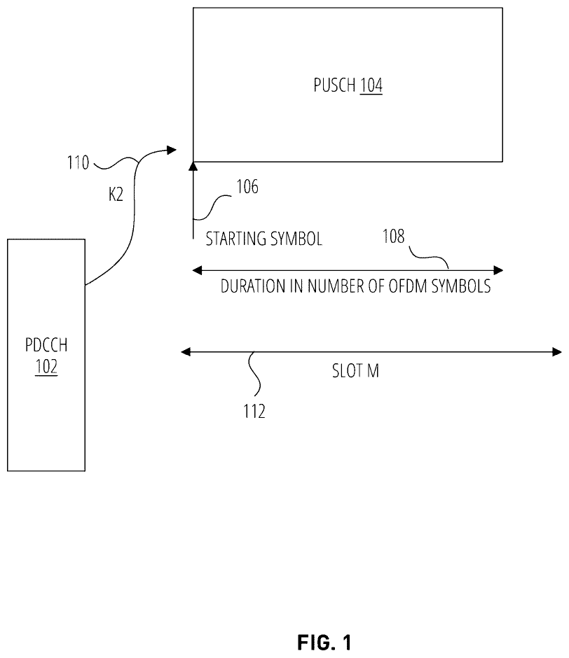

FIG. 1 illustrates a timeline of a physical downlink control channel (PDCCH 102) and a PUSCH 104. Time-Domain Resource Allocation (TDRA) design for PUSCH 104 is about the determination of the starting symbol 106, the duration 108 of a PUSCH 104, also the slot offset 110 (K2) with respect to the PDCCH 102, and the slot duration 112. The starting symbol 106 may not always be the beginning of the slot. A UE may determine these variables for a successful PUSCH 104 transmission.

There are multiple design choices for TDRA. Further, in some embodiments the TDRA design choice for the unlicensed spectrum may be different than the licensed spectrum. Accordingly, it may be desirable to harmonize different design choices.

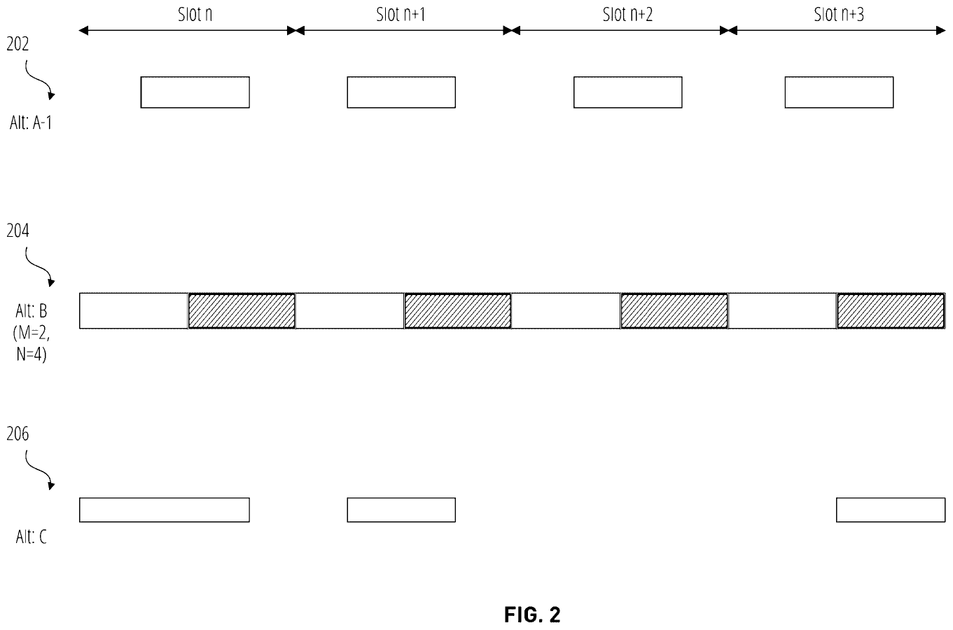

FIG. 2 illustrates three TDRA design choices. In the illustrated embodiment, each of the three design choices are shown with PUSCH transmission occasions mapped to four slots of a CG period.

In a first design choice, Alt A1 202, the TDRA determination may be based on repetition framework. The maximum number of PUSCHs (N) may be configured by higher layers or indicated by activation DCI. The starting symbol(S) and the allocation length (L) may be indicated jointly as Start and Length Indicator Value (SLIV). A single SLIV may be determined from TDRA. The same SLIV may be used in N PUSCH in consecutive slots per CG period. As shown, in ALT A1 202 the PUSCH transmission occasions may have the same start symbol and duration across the slots.

In a second design choice, Alt B 204, the TDRA determination may be based on an NR-U framework. For Alt B 204, N may be configured by higher layers. Additionally, Alt B 204 allows for consecutive PUSCH transmission occasions to occur in a single slot. There may be M consecutive PUSCH transmission occasions with same duration in slot. M may be configured by higher layers. The M PUSCH transmission occasions may be used in N consecutive slots per CG period. N and M may be configured independently from cg-nrofSlots-r16 and cg-nrofPUSCH-InSlot-r16, respectively. M and N configuration may be independent from cgRetransmissionTimer configuration. A single SLIV may be determined from TDRA. The SLIV may be determined by the SLIV used for first PUSCH per CG period. As shown, in Alt B 204 there may be no gaps between PUSCH transmission occasions. This may be preferable for the unlicensed spectrum to ensure devices are able to identify occupied channels.

In the third design choice, Alt C 206, a single DCI scheduling may be used for multiple PUSCHs. The TDRA may be configured by pusch-TimeDomainAllocationListForMultiPUSCH-r16 with extendedK2-r17. A row of TDRA with N entries may determine the time domain resources allocation of N PUSCH transmission occasions per period. The N PUSCH transmission occasions can be non-consecutive PUSCHs and/or in non-consecutive slots. Alt C 206 provides a lot of flexibility. The starting symbol, ending symbol, and duration of each PUSCH transmission occasion may be different, the slots where PUSCH transmission occasions are located can be different. Further, there may be unused slots.

As shown, these TDRA choices operate differently. The use of consecutive and non-consecutive slots may be different. For example, for both Alt A1 202 and Alt B 204, if the number of used slot(s) is more than one, consecutive slots are used. In contrast, Alt C 206 can use un-consecutive slots. The gap between PUSCHs may also be different. For both Alt A1 202 and Alt C 206, a gap between PUSCHs is allowed, but Alt B 204 does not allow a gap between PUSCHs (due to listen before talk (LBT) consideration). Further the design choices may handle the duration of the PSCH differently. For example, Alt C 206 allows different durations for PUSCHs, for Alt A1 202 and Alt B 204 the durations of each of the PUSCHs are identical.

These TDRA designs may be harmonized for more efficient use. For example, Alt A1 202 can be subsumed under Alt B 204. Accordingly, additional focus can be on the harmonization of Alt B 204 and Alt C 206. In 3GPP Release-16, for unlicensed spectrum access, essentially Alt B 204 was used considering the LBT requirement of the unlicensed spectrum access. It may therefore be preferred that the same design is retained for unlicensed spectrum access. However, it may be advantageous to include some of the flexibility of ALT C 206.

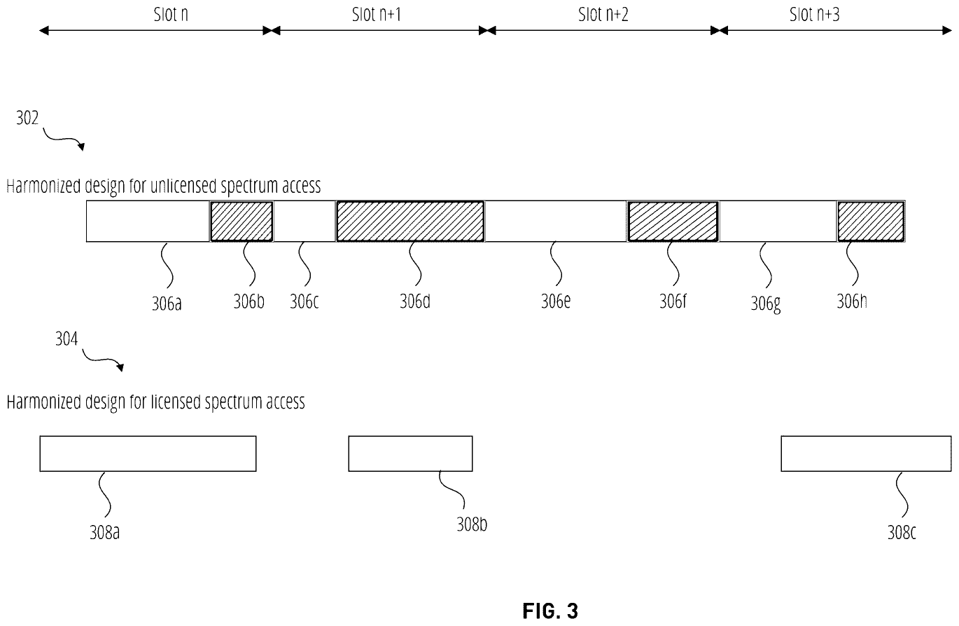

Accordingly, in some embodiments, a transmission schedule without gaps may include flexibility regarding the starting symbol, ending symbol, and duration of each PUSCH transmission occasion. In some embodiments, for unlicensed spectrum access, even if Alt C 206 is used, no gap is allowed between different PUSCHs. Accordingly, PUSCHs may have different durations, but there is no gap between them. For example, FIG. 3 provides an illustration of a way to harmonize Alt B 204 and Alt C 206 in accordance with some embodiments.

FIG. 3 illustrates a transmission timeline 302 for the unlicensed spectrum and a transmission timeline 304 for the licensed spectrum using a harmonized design. As shown, the transmission timeline 304 for the licensed spectrum features the TDRA design of ALT C 206 of FIG. 2. As shown, the three PUSCH transmissions 308a, 308b, and 308c are non-consecutive PUSCHs and/or in non-consecutive slot. Further, the starting symbol, ending symbol, and duration of each PUSCH transmission occasion may be different.

In the illustrated embodiment, the transmission timeline 302 for the unlicensed spectrum includes eight PUSCH transmissions 306a, 306b, 306c, 306d, 306e, 306f, 306g, and 306h with two PUSCH transmissions per slot. Like on the transmission timeline 304 for the licensed spectrum the starting symbol, ending symbol, and duration of each PUSCH transmission occasion may be different. The harmonized TDRA design in the unlicensed spectrum may include multiple PUSCH transmissions in a single slot. The PUSCH transmissions within a slot and across slots do not have gaps between them, but are flexible regarding with the starting symbol, ending symbol, and duration. In some embodiments, there may be a fixed number of PUSCH transmission occasions in a slot as in Alt. B, yet the slots where PUSCH transmission occasions are located are not constrained to be consecutive ones, for example there can be N slots with M transmission occasions in a slot, but their slot indexes may not be consecutive, such as 0, 2, 3, . . . . For Type 2 CG PUSCH configuration activation, this may be also formulated as the slot offsets may not be consecutive for those slots. Then for unlicensed spectrum, the slot offsets/slot indexes are constrained to be consecutive to achieve the effect there is no gap between adjacent PUSCH transmission occasions; alternatively or additionally the OFDM symbols taken by TOs before checking the invalidness of any CG PUSCH are contiguous.

UTO signaling may be enhanced in some embodiments. The UTO signaling may comprise a bitmap where a bit corresponds to a transmission occasion within a time duration/range. The bit indicates whether the transmission is unused. A UE may send the bitmap to a network node over PUSCH as a part of UCI. The network node may use the UTO signaling to make network scheduling decisions.

There are several problems to solve for UTO signaling. For instance, the configuration of the bitmap should be defined. A timing reference for the bitmap and the size of the bitmap are defined in embodiments herein.

Another issue for UTO signaling is that for each CG configuration, there can be its own UTO signaling. If multiple CG configurations are configured, it is unclear whether there should there be any restriction or dependence among the multiple CG configurations from signaling generation perspective. Embodiments herein provide details regarding UTO signaling for multiple CG configurations.

Another issue for UTO signaling is regarding how the indicated UTO signaling affect CG prioritization. For example, if PUSCHs from CG Configuration 1 and PUSCHs from CG configuration 2 overlap, the transmissions and UCI multiplexing determination are defined in embodiments herein.

Another issue for UTO signaling is regarding that a CG configuration can be associated with a physical layer 1 (L1) priority and L2 priority. When two CG configurations with different L1 priorities are configured, it is unclear whether there should be any constriction/dependence among them. Embodiments herein provide details regarding such configurations.

Further, with the UTO signaling, the UE indicates its intention on time occasion (also referred to as transmission occasion) usage to the network. Embodiments herein explore how that indication interacts with network's scheduling behavior (e.g., modifications on the interaction between dynamic grant (DG) PUSCH and CG PUSCH).

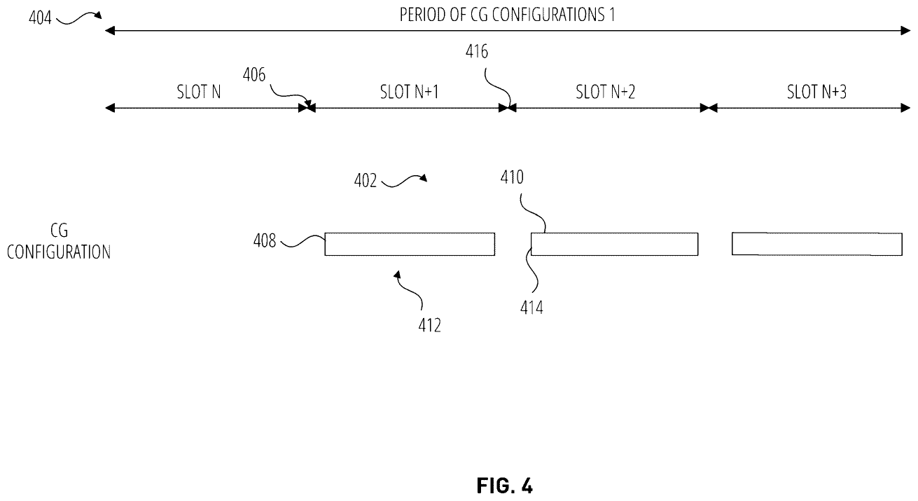

The design of the UTO-UCI may be based on certain factors in some embodiments. Specifically, in some embodiments, the UE may determine the UTO-UCI payload size and the timing reference for the UTO-UCI indication according to a time duration. In some embodiments, the UE may determine the UTO-UCI payload size and the timing reference for the UTO-UCI indication according to multiple CG periods. In some embodiments, the UE may determine the UTO-UCI payload size and the timing reference for the UTO-UCI indication according to range. FIGS. 4-7 provide example of determining the payload size and the timing reference for the UTO-UCI.

FIG. 4 illustrates a series of PUSCH transmissions 402 for a CG configuration in accordance with some embodiments. The time reference and UTO-UCI payload size determination for the PUSCH transmissions 402 may be based on features of the CG configuration. There may be several choices for determining the applicable time duration or range (a number of transmission occasions (TOs)).

For example, the starting time for the UTO that may also be referred to as the time reference or reference time may be based on events within the CG configuration. If an applicable time duration is used, the following are options for the bitmap starting time. In some embodiments, the starting time may be determined by the start time of a CG period per 404. In some embodiments, the starting time may be determined by the slot with an offset in a CG period (e.g., beginning of slot N+1 406 which contains the very first PUSCH transmission occasion or the very first non-invalid PUSCH transmission occasion where a PUSCH transmission occasion is designated as “invalid” if the CG PUSCH for a PUSCH transmission occasion is dropped due to collision with DL symbol(s) indicated by tdd-UL-DL-ConfigurationCommon or tdd-UL-DL-ConfigurationDedicated or SSB). In some embodiments, the starting time may be determined by the starting time of the PUSCH 408 in the first TO in a CG period. In some embodiments, the starting time may be determined by the starting time of the PUSCH 408 in the first TO for a non-invalid CG PUSCH in a CG period. In some embodiments, the starting time may be determined by the starting time of the PUSCH carrying the UTO-UCI. For example, if the second PUSCH 410 is carrying the UTO-UCI and the first PUSCH 412 is not, the starting time 414 of the second PUSCH 410 may be used for the starting time of the UTO. Similar, the starting time may be determined by the starting time of the PUSCH carrying the UTO-UCI (e.g., starting time 416 of PUSCH in slot n+2 if it is the PUSCH carrying UTO-UCI.).

Determination of the UTO-UCI payload size may be based on the maximum number of TOs contained in a time duration from a starting time may be used to determine the UTO-UCI bitmap size. It may be noted that depending on the starting time, the number of TOs enclosed in the time duration may be different. This is because changing the starting time causes the time duration window to slide, and at different points the time duration may include different number of TOs. Accordingly, the UTO-UCI payload size may vary based on time duration and starting time.

In some embodiments, the time duration may be an absolute time (e.g., 1 ms, 5 ms, 50/3 (=16.66 . . . ) ms) which may or may not equal one or multiple of the CG period(s). In some embodiments, the time duration may be a number of uplink slots. In some embodiments, the time duration may be the CG period. In some embodiments, the time duration may be multiple CG periods.

In some embodiments, the bitmap size may be determined according to the number of TOs over a time duration. If the number of TOs over a time duration may vary due to different starting time, the bitmap size may be determined according to the maximum of the number of TOs over a duration with different starting time.

In some embodiments, the bitmap size may be RRC configured for a CG PUSCH configuration. One potential benefit with such a design is to ease UE implementation. In one example, the bitmap size configured by RRC is according to the number of TOs which come after the TO within which the CG PUSCH carrying the UTO-UCI is located, each bit in the bitmap corresponds to such a TO. In another example, the bitmap size configured by RRC is according to the number of TOs which come after the TO within which the CG PUSCH carrying the UTO-UCI is located and those TOs are not associated with an invalid CG PUSCH, each bit in the bitmap corresponds to such a TO.

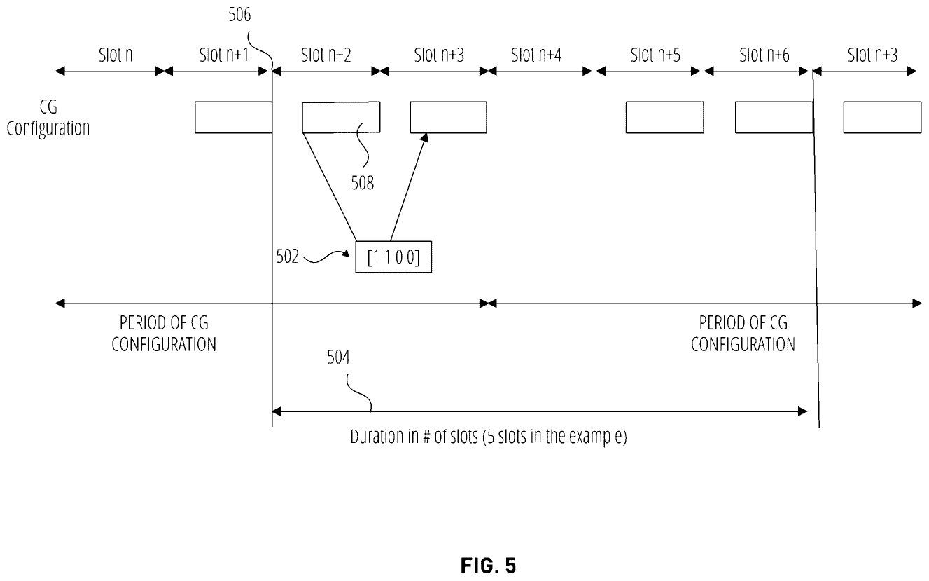

FIG. 5 illustrates a first example bitmap 502 for UTO-UCI in accordance with some embodiments. In the illustrated embodiment, the starting time or timing reference for the UTO indication is determined by the starting time 506 of the slot of the PUSCH 508 containing the UTO-UCI. The time duration 504 of the UTO indication for the illustrated embodiment is based on a number of uplink slots. The number of uplink slots for the time duration 504 is set to five in the illustrated embodiment.

The bitmap size may be determined based on the maximum number of TOs possible with the timing reference (e.g., starting time 506 of the slot of the PUSCH 508 containing the UTO-UCI) and the time duration 504 (e.g., five uplink slots). As show, the timing reference and duration may result in a window of time that captures a number of TOs. In the illustrated example, there are four TOs in the time duration 504. Accordingly, the bitmap 502 is four bits. The first bit representing a first TO, the second bit representing a second TO, the third bit representing a third TO, and the fourth bit representing a fourth TO. A 1 bit may indicate that the UE plans to use the TO, and a 0 bit may indicate that the UE will not use the TO for the CG configuration. Note that in some embodiments, the initial bit may be excluded as it may be assumed that the PUSCH TO containing the UTO-UCI is used.

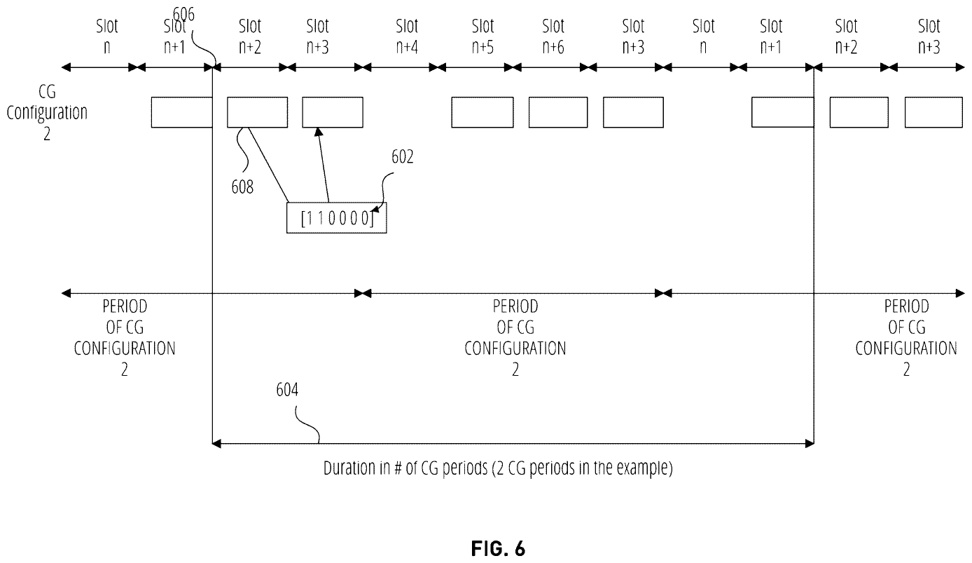

FIG. 6 illustrates a second example bitmap 602 for UTO-UCI in accordance with some embodiments. In the illustrated embodiment, the starting time or timing reference for the UTO indication is determined by the starting time 606 of the slot of the PUSCH 608 containing the UTO-UCI. The time duration 604 of the UTO indication for the illustrated embodiment is based on a number of CG periods. The number of CG periods for the time duration 604 is set to two in the illustrated embodiment.

The bitmap size may be determined based on the maximum number of TOs possible with the timing reference (e.g., starting time 606 of the slot of the PUSCH 608 containing the UTO-UCI) and the time duration 604 (e.g., two CG periods) or with any timing reference at a given time duration. As show, the timing reference and duration may result in a window of time that captures a number of TOs. In the illustrated example, there are six TOs in the time duration 504. Accordingly, the bitmap 502 is six bits. The first bit representing a first TO, the second bit representing a second TO, the third bit representing a third TO, the fourth bit representing a fourth TO, the fifth bit representing a fifth TO, and the sixth bit representing a sixth TO. A 1 bit may indicate that the UE plans to use the TO, and a 0 bit may indicate that the UE will not use the TO for the CG configuration.

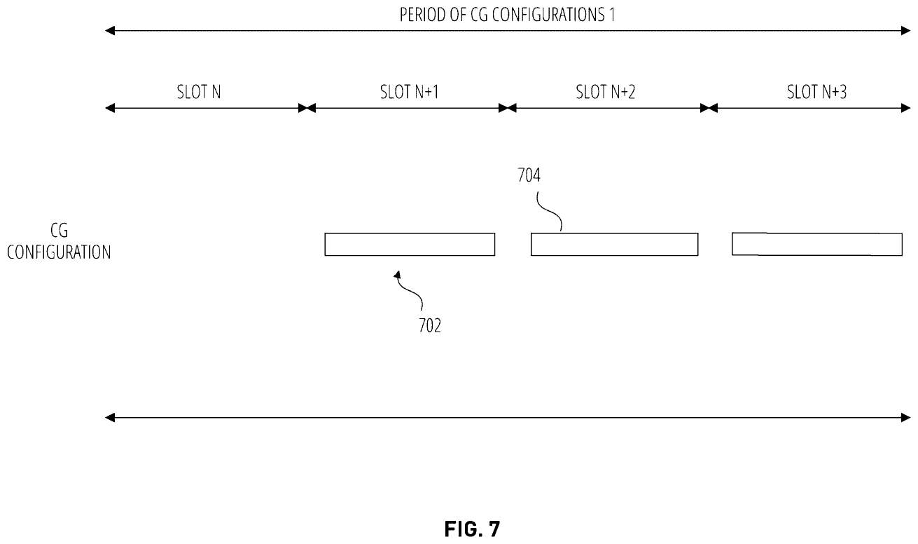

FIG. 7 illustrates a CG configuration timeline in accordance with some embodiments. In some embodiments a TO may be used as a time reference for determining the bitmap size. There may be several choices for determining the applicable time duration or range (a number of TOs) included in a UTO-UCI bitmap. In some embodiments, the starting TO is the first TO 702. In some embodiments, the starting TO is current TO where a CG PUSCH carrying UTO-UCI is transmitted. For example, if the CG PUSCH 704 in slot n+2 is the CG PUSCH carrying UTO-UCI, the starting TO may be used to determine the bitmap size would be CG PUSCH 704. The maximum number of TOs following a starting TO may determine the bitmap size. For instance, if there are a maximum of four TOs for a time duration following a starting TO, the bitmap size may be five. In some embodiments, the TO within which the CG PUSCH carrying the UTO-UCI is located is not included in the bitmap representation.

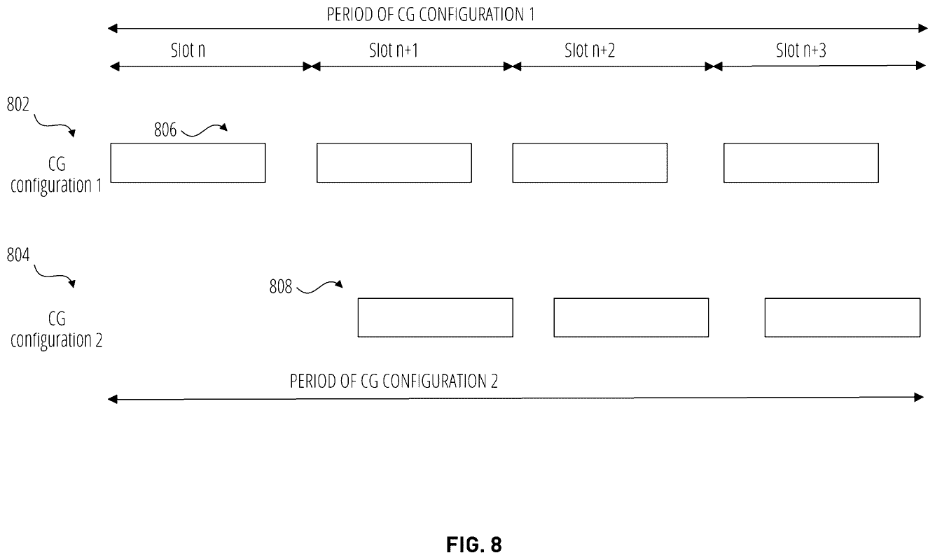

FIG. 8 illustrates two CG configurations in accordance with some embodiments. In the illustrated embodiment, a first CG configuration 802 comprises four TOs 806 in the CG period. The second CG configuration 804 comprises three TOs 808 in the CG period. As shown, the periods and TOs of the first CG configuration 802 and the second CG configuration 804 overlap each other.

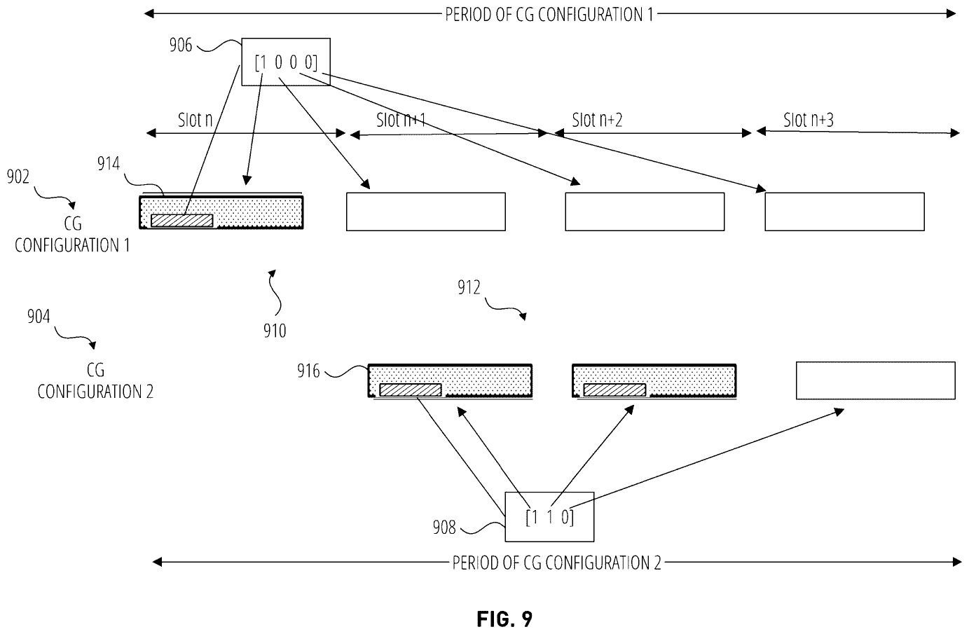

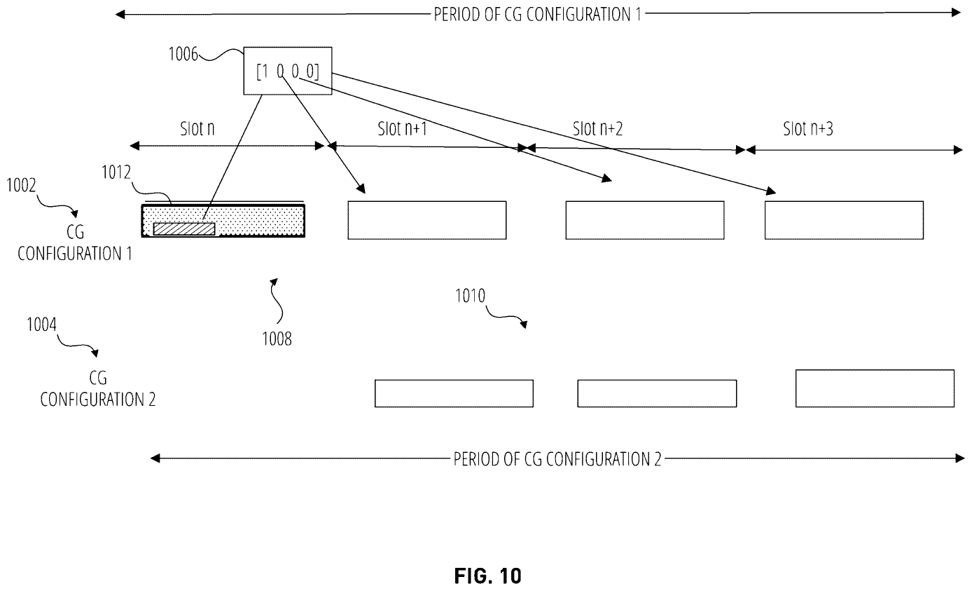

The UTO signaling of one CG configuration may or may not affect the other CG configuration. In some embodiments, there is no restriction or dependence between UTO signaling carried over PUSCHs for different CG configurations at the same L1 priority or different L1 priorities (e.g., the embodiment shown in FIG. 9). In some embodiments, there is a restriction or dependence between UTO signaling carried over PUSCHs for different CG configurations at the same L1 priority or different L1 priorities (e.g., the embodiment shown in FIG. 10).

FIG. 9 illustrates two CG configurations (e.g., first CG configuration 902 and second CG configuration 904) utilizing independent UTO indications (e.g., first UTO indication 906 and second UTO indication 908). In the illustrated embodiment, a first CG configuration 902 comprises four TOs 910 in the CG period. The second CG configuration 904 comprises three TOs 910 in the CG period. As shown, the periods and TOs of the first CG configuration 902 and the second CG configuration 904 overlap each other.

In the illustrated embodiment, there is no restriction/dependence between UTO signaling carried over PUSCHs for different CG configurations at the same L1 priority or different L1 priorities. In this embodiment, the UTO signaling (e.g., first UTO indication 906 and second UTO indication 908) reflects the buffer status or traffic arrival associated with an individual CG configuration. Since the traffic arrival (e.g., for XR video, or file upload) can be different, the indications from UTO signaling carried over PUSCHs for different CG configurations may not be consistent. For instance, the first UTO indication 906 includes a bitmap that signals the used and unused TOs 910 of the first CG configuration 902, and the second UTO indication 908 includes a bitmap that signals the used and unused TOs 912 of the second CG configuration 904.

In the illustrated embodiment, a PUSCH 914 for the first CG configuration 902 in slot n carries UTO signaling with a bitmap of [1000]. The bitmap [1000], with the reference slot starting from slot n, indicates slot n+1, n+2, n+3 are unused. In slot n+1, a PUSCH 916 for the second CG configuration 904 carries UTO signaling with a bitmap of [110]. The bitmap [110], with reference slot starting from slot n, indicates slot n+3 as unused, but slot n+1 & n+2 as “not unused”/“used”. With this design option, the “unused” or “not unused”/“used” status indicated is particular to one or more period of a CG configuration, and bears no relevance to other CG configurations. However, from network node scheduling and blind detection of UTO signaling point of view, it may not be helpful because for slot n+2, if network node schedules the resource vacated by the first CG configuration 902, there is no guarantee there won't be transmission for the UE of interest.

For the illustrated embodiment, there may be no restriction on UTO signaling generation across CG configurations, while consistency may be maintained for UTO signalings generated at different TOs for the same CG configuration. For example, for the second CG configuration 904, the UTO UCI signaling (e.g., second UTO indication 908) may be sent on the PUSCH of both used TOs. The UTO signaling on each of the PUSCH TOs of the second CG configuration 904 are consistent. Whereas, the UTO UCI signaling that is sent on the first CG configuration 902 (e.g., first UTO indication 906) may be different than the second UTO indication 908.

CG PUSCH generation may not be affected by the UTO signaling for another CG configuration at all. For example, in the illustrated embodiment, the first CG configuration 902 indicates that slots n+1, n+2, and n+3 are unused, but that indication does not affect the CG PUSCH generation for the second CG configuration 904. As shown, the UE sends a CG PUSCH on both slots n+1, n+2 for the second CG configuration 904.

The UTO signaling may have an effect on a network node's blind detection behavior. The UTO signaling for a CG Configuration may help reduce blind detection at the network node for CG PUSCHs corresponding with that CG configuration. For potential transmissions of CG PUSCHs with another CG configuration, the network node may perform blind detection.

The UTO signaling may have an effect on network node scheduling behavior. For example, if it is assumed that there is no interruption on the uplink transmission on the component carrier (CC) of interest (e.g., no dynamic Time Division Duplex (TDD) interaction such as DG PDSCH transmission, aperiodic (AP) CSI-RS transmission, etc.) then the indication of UTO signaling may remain valid for the UE. However, if there is interruption in the uplink transmission (e.g., some TOs deemed usable by the UE initially are not actually usable (e.g., due to dynamic TDD)) then the network node may provide DG PUSCH to drain quickly the buffered data.

FIG. 10 illustrates two CG configurations (e.g., first CG configuration 1002 and second CG configuration 1004) utilizing a single UTO indication 1006 for both CG configurations. In the illustrated embodiment, a first CG configuration 1002 comprises four TOs 1008 in the CG period. The second CG configuration 1004 comprises three TOs 1010 in the CG period. As shown, the periods and TOs of the first CG configuration 1002 and the second CG configuration 1004 overlap each other.

In the illustrated embodiment, there is a restriction/dependence between UTO signaling (e.g., UTO indication 1006 carried over PUSCHs for different CG configurations at the same L1 priority or different L1 priorities. In this embodiment, the UTO signaling (e.g., UTO indication 1006) reflects the buffer status or traffic arrival associated for more than one CG configurations. In this case, the UTO signaling indicates either the referred slots are unused, or the OFDM symbols covered by the CG PUSCH as unused. If two CG PUSCHs with two CG configurations overlap over an OFDM symbol, then if the TO associated with either CG configuration's PUSCH is indicated as unused, then each OFDM symbol within the TO may be deemed “unused” from the UE's point of view. In another word, the UTO signaling is used to indicate unused OFDM symbol(s), and any CG PUSCH containing such an OFDM symbol will not be generated by the UE.

In the illustrated embodiment, once the UTO signaling (UTO indication 1006) in the CG PUSCH 1012 associated with the first CG configuration 1002 in slot n indicates the next three occasions are unused, then CG PUSCHs with second CG configuration 904 are inhibited from generation. For instance, as shown, the UTO indication 1006 includes a bitmap that signals that TOs in slot n+1, n+2 and n+3 are unused by both first CG configuration 1002 and second CG configuration 1004. In this embodiment, the bitmap indicates the use or non-use of the overlapping CG PUSCHs in both the CG configurations. In other words when the bitmap indicates an unused TO, the network node may assume that there will be no transmission in the slot for either CG configuration.

For the illustrated embodiment, there may be a restriction on UTO signaling generation across CG configurations. In the illustrated embodiment, the UTO signaling generated by a UE for a CG configuration shall not conflict with any UTO signaling generated by the UE for the same CG configuration or a different CG configuration. In other words, consistency may be maintained for UTO signaling for other CG configurations.

CG PUSCH generation for a TO at a CG configuration can be inhibited by the UTO signaling indicated to the network node for the same CG configuration or for another CG configuration. For example, if an earlier signaling indicates that a slot a symbol is unused, the UE may not generate a CG PUSCH for either the first CG configuration 1002 or the second CG configuration 1004.

The UTO signaling may have an effect on UCI multiplexing. UCI multiplexing pertinent to CG PUSCH transmission may include the selection of PUSCH for UCI multiplexing for SPS HARQ-ACK codebook multiplexing or DG HARQ-ACK codebook multiplexing. All the inhibited CG PUSCHs may be removed as candidates for UCI multiplexing. Inhibited CG PUSCHs refer to those that the UTO bitmap indicates as unused.

The UTO signaling may have an effect on a network node's blind detection behavior. The UTO signaling for a CG Configuration may help reduce blind detection at the network node for CG PUSCHs with that CG configuration. For potential transmissions of CG PUSCHs with another CG configuration, if they would overlap with one OFDM symbol in a TO indicated as “unused” by any UTO signaling, then blind detection can be safely skipped.

There may be variations of the embodiments shown in FIG. 9 and FIG. 10. For example, the CG configurations can be divided into groups. In some embodiments, within a group, there may be a restriction/dependence between UTO signaling as described with dereference to FIG. 10; across groups, there is no restriction/dependence between UTO signaling carried over PUSCHs for different CG configurations at the same L1 priority or different L1 priorities as described with dereference to FIG. 9. In some embodiments, within a group, there is no restriction/dependence between UTO signaling carried over PUSCHs for different CG configurations at the same L1 priority or different L1 priorities as described with dereference to FIG. 9; across groups, there may be a restriction/dependence between UTO signaling as described with dereference to FIG. 10.

In some embodiments, grouping may be according to Radio Resource Control (RRC) signaling (e.g., by including a group index for each CG configuration). The grouping criterion may include L1 priority. In some embodiments, grouping may be according to L1 priority. For example, group 1 consists of CG configurations of low physical layer priority, and group 2 consists of CG configurations of high physical layer priority. In some embodiments, L1 priority may be one but not the only factor in grouping. For example, there can be 3 groups, and there may be one group at high physical layer priority, two at low physical layer priority. In some embodiments, grouping may be according to Radio Resource Control (RRC) signaling (e.g., by including a group index for a CG configuration) where the CG configuration is configured with UTO-UCI. In some embodiments, grouping may be according to Radio Resource Control (RRC) signaling (e.g., by including a group index for a CG configuration) where the CG configuration may or may not be configured with UTO-UCI, then a CG configuration without being configured with UTO-UCI can still benefit from the UTO-UCI feature. In some embodiment, there a single group by specification or by configuration, a flag can be used in lieu of group index. In some embodiment, if a CG configuration is neither configured with UTO-UCI, nor provided a group index/flag, CG PUSCH generation associated with the CG configuration follow the legacy design as if no UTO-UCI is transmitted by the UE.

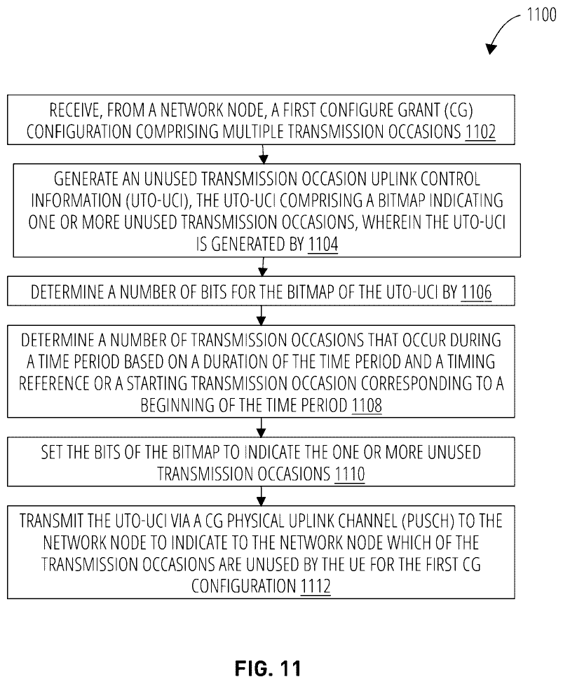

FIG. 11 illustrates a flowchart of a method 1100 for a UE according to embodiments herein. The method 1100 includes receiving 1102, from a network node, a first configure grant (CG) configuration comprising multiple transmission occasions. The method 1100 further includes generating 1104 an unused transmission occasion uplink control information (UTO-UCI), the UTO-UCI comprising a bitmap indicating one or more unused transmission occasions. The method 1100 further includes determining 1106 a number of bits for the bitmap of the UTO-UCI. The method 1100 further includes determining 1108 a number of transmission occasions that occur during a time period based on a duration of the time period and a timing reference or a starting transmission occasion corresponding to a beginning of the time period. The method 1100 further includes setting 1110 the bits of the bitmap to indicate the one or more unused transmission occasions. The method 1100 further includes transmitting 1112 the UTO-UCI via a CG physical uplink channel (PUSCH) to the network node to indicate to the network node which of the transmission occasions are unused by the UE for the first CG configuration.

In some embodiments of the method 1100, the timing reference is determined by one of: a first starting time corresponding to a start of a CG period; a slot with an offset in the CG period where the slot contains the first TO or the first TO associated with a non-invalid CG PUSCH; a second starting time corresponding to a start of a first CG PUSCH in a first transmission occasion in the CG period; a third starting time corresponding to a start of the CG PUSCH carrying the UTO-UCI; or a fourth starting time corresponding to a start of a slot which contains the CG PUSCH carrying the UTO-UCI.

In some embodiments of the method 1100, the duration is one of: an absolute time; a number of uplink slots, the CG period; or multiple CG periods.

In some embodiments of the method 1100, the number of bits for the UTO-UCI is a maximum number of the transmission occasions contained in the duration from the timing reference or over the time duration starting from any starting time (for example, from a first starting time, there are 4 TOs in a time period; from a second starting time there are 5 TOs in a time period, then the bitmap size is 5 (maybe this sentence can be moved earlier)).

In some embodiments of the method 1100, the starting transmission occasion is a first transmission occasion in a CG period or a current transmission occasion where the CG PUSCH carrying the UTO-UCI is transmitted.

In some embodiments of the method 1100, a maximum number of transmission occasions following the starting transmission occasion is used to determine the number of bits.

In some embodiments, the method 1100 further comprises receiving, from the network node, a second CG configuration overlapping the first CG configuration. The method 1100 may further comprise generating a second UTO-UCI for the second CG configuration, wherein the second UTO-UCI is independent of the UTO-UCI of the first CG configuration. The method 1100 may further comprise transmitting the second UTO-UCI via a different CG PUSCH in the second CG configuration to the network node to indicate to the network node which of the transmission occasions are unused by the UE for the second CG configuration. The method 1100 may further comprise generating and sending PUSCH transmissions according to the UTO-UCI for the first CG configuration and the second UTO-UCI for the second CG configuration.

In some embodiments, the method 1100 further comprises receiving, from the network node, a second CG configuration overlapping the first CG configuration. The method 1100 may further comprise generating and sending PUSCH transmissions for transmission occasions of the second CG configuration, wherein the UTO-UCI of the first CG configuration restricts which of the transmission occasions of the second CG configuration can be used.

In some embodiments, the method 1100 further comprises sending PUSCH transmissions in an unlicensed spectrum, wherein the PUSCH transmissions are sent consecutively with varying lengths.

Embodiments contemplated herein include an apparatus comprising means to perform one or more elements of the method 1100. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of the method 1100. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a UE (such as a wireless device 1402 that is a UE, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

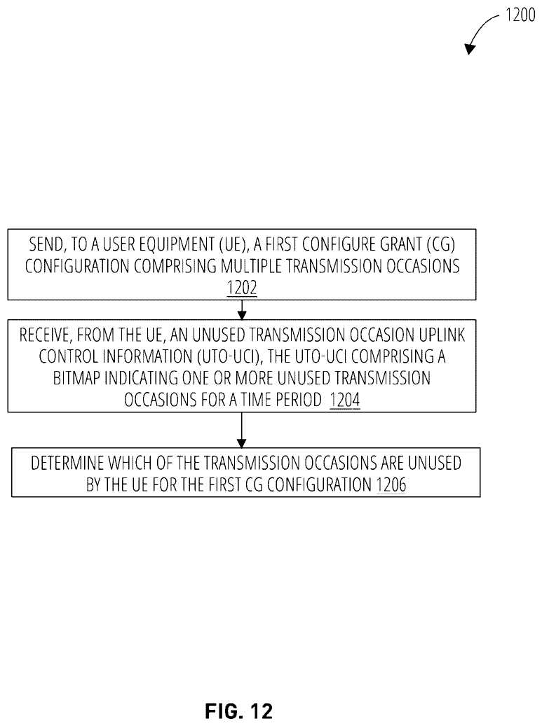

FIG. 12 illustrates a flowchart of a method 1200 for a network node according to embodiments herein. The method 1200 includes sending 1202, to a user equipment (UE), a first configure grant (CG) configuration comprising multiple transmission occasions. The method 1200 includes receiving 1204, from the UE, an unused transmission occasion uplink control information (UTO-UCI), the UTO-UCI comprising a bitmap indicating one or more unused transmission occasions for a time period. In some embodiments, the size of the bitmap of the UTO-UCI is determined by a number of transmission occasions that occur during the time period based on a duration of the time period and a timing reference or a starting transmission occasion corresponding to a beginning of the time period. The method 1200 includes determining 1206 which of the transmission occasions are unused by the UE for the first CG configuration.

In some embodiments of the method 1200, the timing reference is determined by one of: a first starting time corresponding to a start of a CG period; a slot with an offset in the CG period; a second starting time corresponding to a start of a first CG PUSCH in a first transmission occasion in the CG period; a third starting time corresponding to a start of the CG PUSCH carrying the UTO-UCI; or a fourth starting time corresponding to a start of a slot which contains the CG PUSCH carrying the UTO-UCI.

In some embodiments of the method 1200, the duration is one of: an absolute time; a number of uplink slots, the CG period; or multiple CG periods.

In some embodiments of the method 1200, the size of the bitmap for the UTO-UCI is a maximum number of the transmission occasions contained in the duration from the timing reference.

In some embodiments of the method 1200, the starting transmission occasion is a first transmission occasion in a CG period or a current transmission occasion where the CG PUSCH carrying the UTO-UCI is transmitted.

In some embodiments of the method 1200, a maximum number of transmission occasions following the starting transmission occasion is used to determine the size of the bitmap.

In some embodiments, the method 1200 further comprises sending, to the UE, a second CG configuration overlapping the first CG configuration. The method 1200 may further comprise receiving, from the UE, a second UTO-UCI for the second CG configuration, wherein the second UTO-UCI is independent of the UTO-UCI of the first CG configuration. The method 1200 may further comprise determining which of the transmission occasions are unused by the UE for the second CG configuration. The method 1200 may further comprise receiving, from the UE, PUSCH transmissions according to the UTO-UCI for the first CG configuration and the second UTO-UCI for the second CG configuration.

In some embodiments, the method 1200 further comprises sending, to the UE, a second CG configuration overlapping the first CG configuration. The method 1200 may further comprise receiving, from the UE, PUSCH transmissions for transmission occasions of the second CG configuration, wherein the UTO-UCI of the first CG configuration restricts which of the transmission occasions of the second CG configuration can be used.

In some embodiments, the method 1100 further comprises receiving, from the UE, PUSCH transmissions in an unlicensed spectrum, wherein the PUSCH transmissions are sent consecutively with varying lengths.

Embodiments contemplated herein include an apparatus comprising means to perform one or more elements of the method 1200. This apparatus may be, for example, an apparatus of a base station (such as a network device 1418 that is a base station, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a base station (such as a memory 1422 of a network device 1418 that is a base station, as described herein).

Embodiments contemplated herein include an apparatus comprising logic, modules, or circuitry to perform one or more elements of the method 1200. This apparatus may be, for example, an apparatus of a base station (such as a network device 1418 that is a base station, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a base station (such as a network device 1418 that is a base station, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of a base station (such as a processor(s) 1420 of a network device 1418 that is a base station, as described herein). These instructions may be, for example, located in the processor and/or on a memory of the base station (such as a memory 1422 of a network device 1418 that is a base station, as described herein).

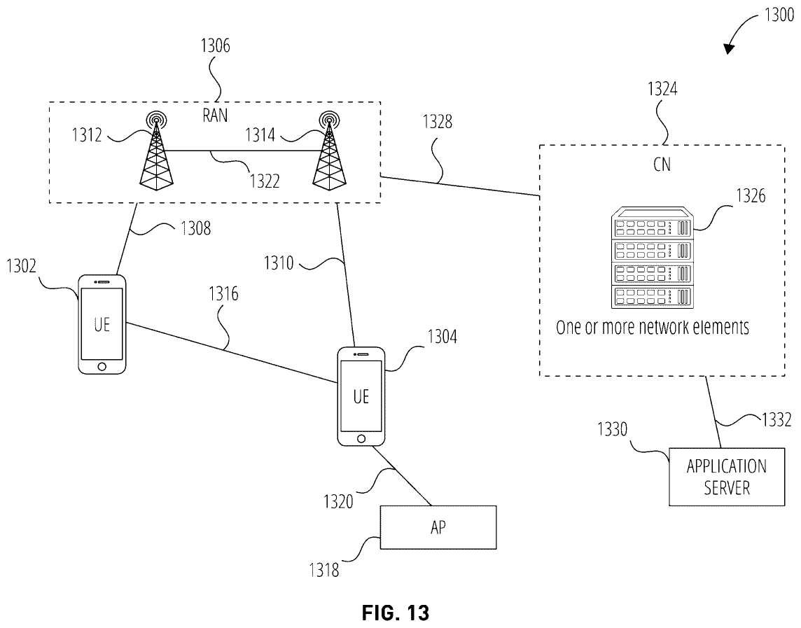

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations (such as base station 1312 and base station 1314) that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VoIP sessions, group communication sessions, etc.) for the UE 1302 and UE 1304 via the CN 1324. The application server 1330 may communicate with the CN 1324 through an IP communications interface 1332.

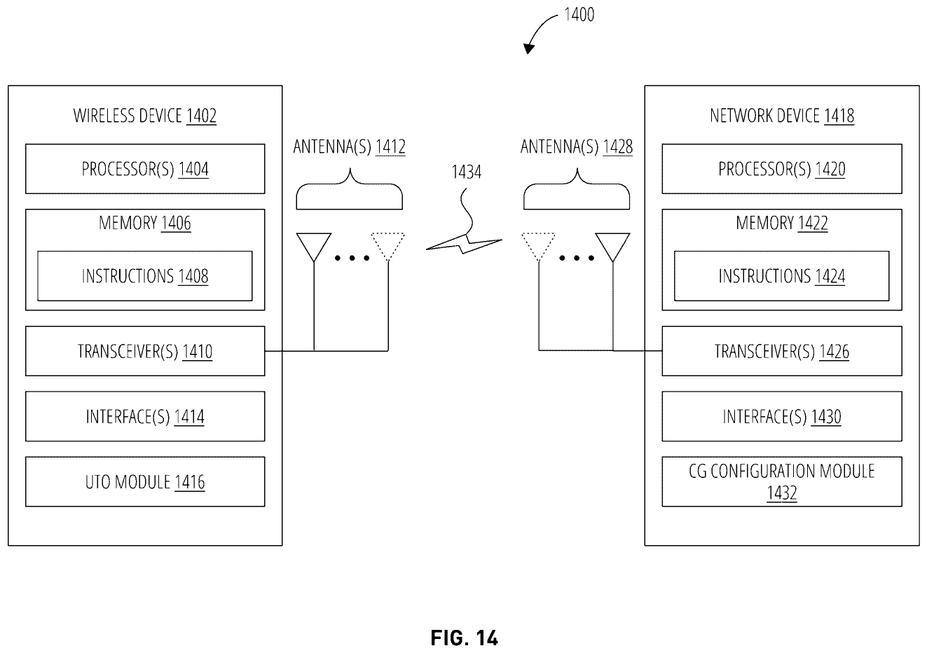

FIG. 14 illustrates a system 1400 for performing signaling 1434 between a wireless device 1402 and a network device 1418, according to embodiments disclosed herein. The system 1400 may be a portion of a wireless communications system as herein described.

The wireless device 1402 may be, for example, a UE of a wireless communication system. The network device 1418 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter circuitry and/or receiver circuitry that use the antenna(s) 1412 of the wireless device 1402 to facilitate signaling (e.g., the signaling 1434) to and/or from the wireless device 1402 with other devices (e.g., the network device 1418) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include a UTO module 1416. The UTO module 1416 may be implemented via hardware, software, or combinations thereof. For example, the UTO module 1416 may be implemented as a processor, circuit, and/or instructions 1408 stored in the memory 1406 and executed by the processor(s) 1404. In some examples, the UTO module 1416 may be integrated within the processor(s) 1404 and/or the transceiver(s) 1410. For example, the UTO module 1416 may be implemented by a combination of software components (e.g., executed by a DSP or a general processor) and hardware components (e.g., logic gates and circuitry) within the processor(s) 1404 or the transceiver(s) 1410.

The UTO module 1416 may be used for various aspects of the present disclosure, for example, aspects of FIGS. 1-13. The UTO module 1416 is configured to generate a UTO as described herein.

The network device 1418 may include one or more processor(s) 1420. The processor(s) 1420 may execute instructions such that various operations of the network device 1418 are performed, as described herein. The processor(s) 1420 may include one or more baseband processors implemented using, for example, a CPU, a DSP, an ASIC, a controller, an FPGA device, another hardware device, a firmware device, or any combination thereof configured to perform the operations described herein.

The network device 1418 may include a memory 1422. The memory 1422 may be a non-transitory computer-readable storage medium that stores instructions 1424 (which may include, for example, the instructions being executed by the processor(s) 1420). The instructions 1424 may also be referred to as program code or a computer program. The memory 1422 may also store data used by, and results computed by, the processor(s) 1420.

The network device 1418 may include one or more transceiver(s) 1426 that may include RF transmitter circuitry and/or receiver circuitry that use the antenna(s) 1428 of the network device 1418 to facilitate signaling (e.g., the signaling 1434) to and/or from the network device 1418 with other devices (e.g., the wireless device 1402) according to corresponding RATs.

The network device 1418 may include one or more antenna(s) 1428 (e.g., one, two, four, or more). In embodiments having multiple antenna(s) 1428, the network device 1418 may perform MIMO, digital beamforming, analog beamforming, beam steering, etc., as has been described.

The network device 1418 may include one or more interface(s) 1430. The interface(s) 1430 may be used to provide input to or output from the network device 1418. For example, a network device 1418 that is a base station may include interface(s) 1430 made up of transmitters, receivers, and other circuitry (e.g., other than the transceiver(s) 1426/antenna(s) 1428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1418 may include a CG configuration module 1432. The CG configuration module 1432 may be implemented via hardware, software, or combinations thereof. For example, the CG configuration module 1432 may be implemented as a processor, circuit, and/or instructions 1424 stored in the memory 1422 and executed by the processor(s) 1420. In some examples, the CG configuration module 1432 may be integrated within the processor(s) 1420 and/or the transceiver(s) 1426. For example, the CG configuration module 1432 may be implemented by a combination of software components (e.g., executed by a DSP or a general processor) and hardware components (e.g., logic gates and circuitry) within the processor(s) 1420 or the transceiver(s) 1426.

The CG configuration module 1432 may be used for various aspects of the present disclosure, for example, aspects of FIGS. 1-13. The CG configuration module 1432 is configured to provide a CG configuration, receive a UTO, and determine unused TOs based on the UTO.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein.

For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for wireless communication by a user equipment (UE), the method comprising:
receiving, from a network node, a first configure grant (CG) configuration comprising multiple transmission occasions;
generating an unused transmission occasion uplink control information (UTO-UCI), the UTO-UCI comprising a bitmap indicating one or more unused transmission occasions, wherein the UTO-UCI is generated by:
determining a number of bits for the bitmap of the UTO-UCI by:
determining a number of transmission occasions that occur during a time period based on a duration of the time period and a timing reference or a starting transmission occasion corresponding to a beginning of the time period; and
setting the bits of the bitmap to indicate the one or more unused transmission occasions; and
transmitting the UTO-UCI, via a CG physical uplink channel (PUSCH), to the network node to indicate to the network node which of the transmission occasions are unused by the UE for the first CG configuration.

2. The method of claim 1, wherein the timing reference is determined by one of:
a first starting time corresponding to a start of a CG period;
a slot with an offset in the CG period;
a second starting time corresponding to a start of a first CG PUSCH in a first transmission occasion in the CG period;
a third starting time corresponding to a start of the CG PUSCH carrying the UTO-UCI; or
a fourth starting time corresponding to a start of a slot which contains the CG PUSCH carrying the UTO-UCI.

3. The method of claim 2, wherein the duration is one of:
an absolute time;
a number of uplink slots,
the CG period; or
multiple CG periods or
the number of transmission occasions signaled by RRC.

4. The method of claim 3, wherein the number of bits for the UTO-UCI is a maximum number of the transmission occasions contained in the duration from the timing reference.

5. The method of claim 1, wherein the starting transmission occasion is a first transmission occasion in a CG period or a current transmission occasion where the CG PUSCH carrying the UTO-UCI is transmitted.

6. The method of claim 5, wherein a maximum number of transmission occasions following the starting transmission occasion is used to determine the number of bits.

7. The method of claim 1, further comprising:
receiving, from the network node, a second CG configuration overlapping the first CG configuration;
generating a second UTO-UCI for the second CG configuration, wherein the second UTO-UCI is independent of the UTO-UCI of the first CG configuration;
transmitting the second UTO-UCI via a different CG PUSCH in the second CG configuration to the network node to indicate to the network node which of the transmission occasions are unused by the UE for the second CG configuration; and
generating and sending PUSCH transmissions according to the UTO-UCI for the first CG configuration and the second UTO-UCI for the second CG configuration.

8. The method of claim 1, further comprising:
receiving, from the network node, a second CG configuration overlapping the first CG configuration;
generating and sending PUSCH transmissions for transmission occasions of the second CG configuration, wherein the UTO-UCI of the first CG configuration restricts which of the transmission occasions of the second CG configuration can be used.

9. The method of claim 1, further comprising sending PUSCH transmissions in an unlicensed spectrum, wherein the PUSCH transmissions are sent consecutively with varying lengths.

10. A method for wireless communication by a network node, the method comprising:
sending, to a user equipment (UE), a first configure grant (CG) configuration comprising multiple transmission occasions;
receiving, from the UE, an unused transmission occasion uplink control information (UTO-UCI), the UTO-UCI comprising a bitmap indicating one or more unused transmission occasions for a time period,
wherein the size of the bitmap of the UTO-UCI is determined by a number of transmission occasions that occur during the time period based on a duration of the time period and a timing reference or a starting transmission occasion corresponding to a beginning of the time period; and
determining which of the transmission occasions are unused by the UE for the first CG configuration.

11. The method of claim 10, wherein the timing reference is determined by one of:
a first starting time corresponding to a start of a CG period;
a slot with an offset in the CG period;
a second starting time corresponding to a start of a first CG PUSCH in a first transmission occasion in the CG period;
a third starting time corresponding to a start of the CG PUSCH carrying the UTO-UCI; or
a fourth starting time corresponding to a start of a slot which contains the CG PUSCH carrying the UTO-UCI.

12. The method of claim 11, wherein the duration is one of:
an absolute time;
a number of uplink slots,
the CG period; or
multiple CG periods; or
the number of transmission occasions signaled by RRC.

13. The method of claim 12, wherein the size of the bitmap for the UTO-UCI is a maximum number of the transmission occasions contained in the duration from the timing reference.

14. The method of claim 10, wherein the starting transmission occasion is a first transmission occasion in a CG period or a current transmission occasion where the CG PUSCH carrying the UTO-UCI is transmitted.

15. The method of claim 14, wherein a maximum number of transmission occasions following the starting transmission occasion is used to determine the size of the bitmap.

16. The method of claim 10, further comprising:
sending, to the UE, a second CG configuration overlapping the first CG configuration;
receiving, from the UE, a second UTO-UCI for the second CG configuration, wherein the second UTO-UCI is independent of the UTO-UCI of the first CG configuration;
determining which of the transmission occasions are unused by the UE for the second CG configuration; and
receiving, from the UE, PUSCH transmissions according to the UTO-UCI for the first CG configuration and the second UTO-UCI for the second CG configuration.

17. The method of claim 10, further comprising:
sending, to the UE, a second CG configuration overlapping the first CG configuration;
receiving, from the UE, PUSCH transmissions for transmission occasions of the second CG configuration, wherein the UTO-UCI of the first CG configuration restricts which of the transmission occasions of the second CG configuration can be used.

18. The method of claim 10, further comprising receiving, from the UE, PUSCH transmissions in an unlicensed spectrum, wherein the PUSCH transmissions are sent consecutively with varying lengths.

19. A user equipment (UE) apparatus comprising:
a processor; and
a memory storing instructions that, when executed by the processor, configure the apparatus to:
receive, from a network node, a first configure grant (CG) configuration comprising multiple transmission occasions;
generate an unused transmission occasion uplink control information (UTO-UCI), the UTO-UCI comprising a bitmap indicating one or more unused transmission occasions, wherein the UTO-UCI is generated by:
determine a number of bits for the bitmap of the UTO-UCI by:
determine a number of transmission occasions that occur during a time period based on a duration of the time period and a timing reference or a starting transmission occasion corresponding to a beginning of the time period; and
set the bits of the bitmap to indicate the one or more unused transmission occasions; and
transmit the UTO-UCI, via a CG physical uplink channel (PUSCH), to the network node to indicate to the network node which of the transmission occasions are unused by the UE for the first CG configuration.

20. The UE apparatus of claim 19, wherein the timing reference is determined by one of:
a first starting time corresponding to a start of a CG period;
a slot with an offset in the CG period;
a second starting time corresponding to a start of a first CG PUSCH in a first transmission occasion in the CG period;
a third starting time corresponding to a start of the CG PUSCH carrying the UTO-UCI; or
a fourth starting time corresponding to a start of a slot which contains the CG PUSCH carrying the UTO-UCI.

21-36. (canceled)
